(19) United States
(12) Patent Application Publication
(10) Pub. No.: US 2011/0285644 A1
(43) Pub. Date: Nov. 24, 2011

(54) ELECTRONIC DEVICE WITH TOUCH PANEL

(75) Inventors: LING CHANG, Shenzhen City (CN); HUA-DONG CHENG, Shenzhen City (CN); CHIH-SAN CHIANG, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/944,644

(22) Filed: Nov. 11, 2010

(30) Foreign Application Priority Data
May 19, 2010 (CN) 201010176847.7

(51) Int. Cl. G06F 3/041

(52) U.S. Cl. 345/173

(57) ABSTRACT

An electronic device includes a display unit and a touch panel. The display unit includes at least two display areas, wherein each of the display areas has a unique operation frequency. The touch panel is installed in front of the display unit and includes at least two touch areas corresponding to the display areas, each of the touch areas is scanned with a unique scan frequency corresponding to the unique operation frequency of the corresponding display area. Through partition design for the GUI, the electronic device can respectively scan the touch areas, which replace the existing scanning method to scan the whole touch panel, and it is more efficient.

### BACKGROUND

1. Technical Field

The present disclosure relates to electronic devices and, particularly, to a electronic device with a touch panel.

2. Description of Related Art

The graphical user interface (GUI) has been adopted by most operating systems, cooperating with touch panels, people can operate simply through the windows, menu, and keys. However, the whole display of conventional electronic devices with GUI must be updated even if changes only occur in part of the display area, and the touch controller must scan the whole touch area to detect whether there's a touch event and the location of the touch event. The problems mentioned above lead to increased power consumption.

### BRIEF DESCRIPTION OF THE DRAWINGS

The components of the drawings are not necessarily drawn to scale, the emphasis instead being placed upon clearly illustrating the principles of an electronic device with touch panel. Moreover, in the drawings, like reference numerals designate corresponding parts throughout several views.

FIG. 1 is a block diagram of the electronic device in accordance with an exemplary embodiment.

FIG. 2 is a schematic diagram of the display areas of a display unit of the electronic device of FIG. 1, in accordance with an exemplary embodiment.

FIG. 3 is a schematic diagram of touch areas of a touch panel of the electronic device of FIG. 1, in accordance with an exemplary embodiment.

### DETAILED DESCRIPTION

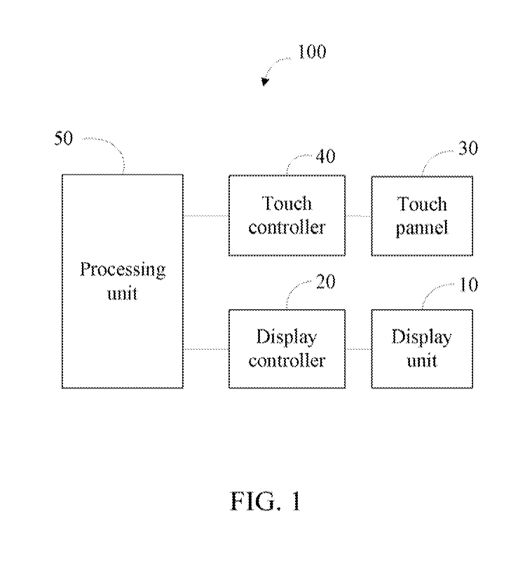

FIG. 1 is a view showing a block diagram of an electronic device 100, in accordance with an exemplary embodiment. The electronic device 100 can be, for example, a mobile telephone, a personal digital assistant (PDA), or an e-book reader. To facilitate the presentation, in this embodiment, the electronic device 100 is an e-book Reader.

The electronic device 100 includes a display unit 10, a display controller 20, a touch panel 30, a touch controller 40, and a processing unit 50. The touch panel 30 is transparent and is installed in front of the display unit 10. The touch panel 30 and the display unit 10 constitute a touch screen. The display controller 20 drives the display unit 10 to display a graphical user interface (GUI) on the display unit 10.

The GUI includes icons, windows, pointers, and animations, etc. When a user touches a position of the touch panel 30 to start an icon at a corresponding position of the display unit 10, the touch controller 40 identifies a position of the touch on the touch panel 30 and sends the position information to the processing unit 50. The processing unit 50 identifies the icon touched according to the position information and then commands to execute the function represented by the icon.

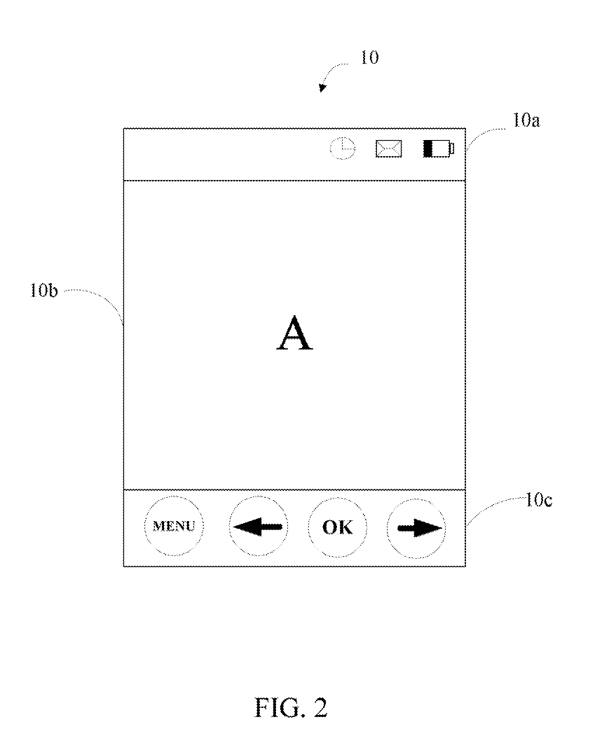

Referring to FIG. 2, the display unit 10 is divided into at least two display areas. Each of the display areas displays a group of icons, and the operation frequency of each of the display areas is based on the operation frequencies of the icons in this area. For example, the operation frequency of each of the display areas is the average of the frequencies of the icons in this area. In this embodiment, the operation frequency is a parameter that indicates how often an icon or an area generally is touched.

In this embodiment, the display unit 10 includes an unchanged area 10a, a content area 10b, and an operable area 10c. The unchanged area 10a can display icons including an alarm clock icon, a message icon, a battery level icon, the operation frequencies of those icons are low because that the icons display information to users but are not provided for users to operate, therefore, the operation frequency of this area 10a is relatively low based on the low operation frequencies of the icons in the unchanged area 10a. The content area 10b displays digital contents such as text, and images, the operation frequencies of the contents are low because that the contents are not need to be operated, therefore, the operation frequency of this area 10b is also relatively low based on the low operation frequencies of the contents in the content area 10b. The operable area 10c displays icons including a previous button, a next button, a menu button, and an OK button, those icons are provided for users to operate, for example, to control the content in the content area 10b, therefore, the operation frequency of this area 10c is also relatively high based on the operation frequencies of the icons in the content area 10c.

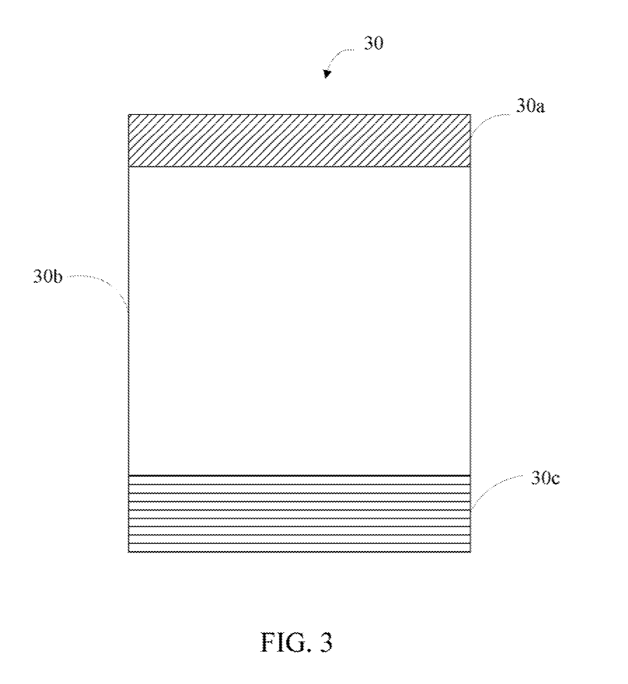

Referring to FIG. 3, the touch panel 30 is also divided into at least two touch areas corresponding to the number and the locations of the display areas. The touch controller 40 scans each of the touch areas independently according their respective scanning frequencies. In one embodiment, the touch controller 20 scans each of the touch areas with a scanning frequency corresponding to the operation frequency for the corresponding display area.

In this embodiment, the touch panel 30 includes a first touch area 30a, a second touch area 30b, and a third touch area 30c, corresponding to the unchanged area 10a, the content area 10b, and the operable area 10c. As mentioned above, the operation frequencies of the unchanged area 10a and the content area 10b are relatively low, the operation frequency of the operable area 10c is relatively high, thus the touch controller 40 scans the first touch area 30a and the second touch area 30b with relatively low scanning frequencies, and scans the third touch area 30c with a relatively high scanning frequency. In this way, the touch controller 40 disparately scans the touch areas with corresponding scanning frequency, to meet the needs of those touch areas but also saves energy.

Through partitioning the GUI, the electronic device 100 can respectively scan the touch areas, which replaces the existing scanning method to scan the whole touch panel. Therefore, it is more efficient.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device comprising:
a processing unit;
an display unit divided into at least two display areas, wherein each of the display areas for displaying a group of icons, and each of the display areas has an operation frequency based on the frequencies of the group of icons in the display area;
a display controller configured to drive the display unit to display the groups of icons under control of the processing unit;
a touch panel installed in front of the display unit and divided into at least two touch areas corresponding to the number and the locations of the display areas; and
a touch controller configured to identify a position of a touch on the touch panel and send the position information to the processing unit;
wherein the touch controller scans each touch area with a scanning frequency corresponding to the operation frequency for the icons in the corresponding display area, and wherein the processing unit identifies the icon being touched according to the position information and commands to execute the function represented by the icon.

2. The electronic device as claimed in claim 1, wherein the display areas comprises a unchanged area, the unchanged area displays a group of icons whose operation frequencies are low, the operation frequency of this area is relatively low based on the low operation frequencies of the icons in the unchanged area, and the touch controller scans the one of the touch areas corresponding to the unchanged area with a relatively low scanning frequency.

3. The electronic device as claimed in claim 1, wherein the display areas comprises a content area, the content area displays digital contents whose operation frequencies are relatively low, the operation frequency of the content area is relatively low based on the low operation frequencies of the contents in the content area, and the touch controller scans one of the touch areas corresponding to the content area with a relatively low scanning frequency.

4. The electronic device as claimed in claim 1, wherein the display areas comprises an operable area, the operable area displays icons whose operation frequencies are relatively high, the operation frequency of this area is also relatively high based on the high operation frequencies of the icons in the operable area, and the touch controller scans one of the touch areas corresponding to the operable area with a relatively high scanning frequency.

5. An electronic device comprising:
a processing unit;
a display unit including an operable area and a content area, wherein the operable area has a relatively high operation frequency and the content area has a relatively low operation frequency;
a display controller configured to drive the display unit under control of the processing unit;
a touch panel installed in front of the display unit and comprising a first and a second touch area corresponding to the operable area and the content area; and
a touch controller configured to identify a position of a touch on the touch panel and send the position information to the processing unit.

6. The electronic device as claimed in claim 5, wherein the content area is provided for displaying digital contents and the operable area is provided for displaying icons for users to operate the digital contents in the content area.

7. An electronic device comprising:
a display unit including at least two display areas, wherein each of the display area has an unique operation frequency; and
a touch panel installed in front of the display unit and including at least two touch areas corresponding to the display areas, each of the touch areas being scanned with a unique scan frequency corresponding to the unique operation frequency of the corresponding display area.
